(19) United States
(12) Patent Application Publication
(10) Pub. No.: US 2008/0120570 A1
(43) Pub. Date: May 22, 2008

(54) Methods for managing windows within an internet environment and systems thereof

(75) Inventors: Kyle Adams, Rochester, NY (US); David A. Koretz, Pittsford, NY (US); John Fitzgerald, Penfield, NY (US); Anthony Quinn, Macedon, NY (US); Angelo DiNardi, Pittsburgh, PA (US)

Correspondence Address: NIXON PEABODY LLP - PATENT GROUP, 1100 CLINTON SQUARE, ROCHESTER, NY, 14604, US

(73) Assignee: BlueTie, Inc., Pittsford, NY (US)

(21) Appl. No.: 11/603,430

(22) Filed: Nov. 22, 2006

(51) Int. Cl. G06F 3/048

(52) U.S. Cl. 715/804

(57) ABSTRACT

A method, computer readable medium, and system for managing windows within an Internet environment includes determining at a first system which of one or more of settings to use for one or more windows within an Internet browser window in a second system remote from the first system. At least one of one or more attributes in the one or more settings is adjustable. The one or more windows with the determined one of the settings are docked in the Internet browser window in the second system.

### FIELD OF THE INVENTION

This invention relates to generating, controlling and displaying of one or more windows within an Internet browser window to provide functionality, including moving, sizing, maximization, minimization, opening, closing, docking, undocking, and overlaying of windows, without any client side software.

### BACKGROUND

Windowing systems allow a computer operator to work simultaneously within multiple applications at the same time. Each application exists within a separate window, with the combination of all windows residing in a single environment known as the computer desktop.

A recent system, such as the one disclosed in U.S. Pat. No. 7,051,288 to Bennett, et al. which is herein incorporated by reference in its entirety, allows a Java based desktop to provide window manager services on UNIX, but does not work in a Web-based environment. Additionally, this system requires the user to use a Unix based computing environment and is not universal across other operating systems. Further, this system lacks the ability to produce windows with different shapes or windows with different opacities or colors.

Today's Internet web browsers do not have the ability to do windowing natively and require the use of frames to display information to a user in multiple windows. These frames are inflexible and exist on a single plane (X,Y), in a relative position. Additionally, they generally cannot be moved from their relative position, to perform maneuvers, such as laying frames on top of one another or moving entire frames left to right or right to left. Further, the frames are slow for the client computer to render, as the entire frame must typically be downloaded before it can be displayed to the user.

Other existing Web-based windowing systems lack the capability to enable the docking and relative scaling of the entire windowing system. These prior other systems merely replicate the existing Windowing systems on the desktop computing paradigm. They do not allow relative scaling of size, which is critical in Web-based applications where the screen resolutions change from computer to computer and the user can re-size the browser if desired. Further, these other prior systems lack the ability to dock windows. Additionally, since users already have windowing functionality on the desktop, replicating it with floating windows on the Web has limited value. Since most of the applications the average user runs are still on the desktop computer, these other prior systems cannot replace existing desktop windowing systems, but rather necessitate the use of two windowing systems simultaneously creating confusion for the user. Further, none of these prior systems communicate with the desktop computer to detect resolution or allow the user to store preferred layouts in cookies or in a centralized server location. This forces the user to perform manual work every time they use the windowing system.

### SUMMARY

A method for managing windows within an Internet environment in accordance with embodiments of the present invention includes determining at a first system which of one or more of settings to use for one or more windows within an Internet browser window in a second system remote from the first system. At least one of one or more attributes in the one or more settings is adjustable. The one or more windows with the determined one of the settings are docked in the Internet browser window in the second system.

A computer readable medium having stored thereon instructions for managing windows within an Internet environment comprising machine executable code executable by at least one processor in accordance with other embodiments of the present invention includes determining at a first system which of one or more of settings to use for one or more windows within an Internet browser window in a second system remote from the first system. At least one of one or more attributes in the one or more settings is adjustable. The one or more windows with the determined one of the settings are docked in the Internet browser window in the second system.

A system for managing windows within an Internet environment in accordance with other embodiments of the present invention includes a determination processing system and a docking system. The determination processing system determines at a first system which of one or more of settings to use for one or more windows within an Internet browser window in a second system remote from the first system. At least one of one or more attributes in the one or more settings is adjustable. The docking system docks the one or more windows with the determined one of the settings in the Internet browser window in the second system

The present invention provides a number of advantages including providing dynamic management over the display of one or more windows within an Internet browser window. The present invention allows attributes to be selected for settings for the windows, such as size of the windows, relative position of the windows to be displayed, color of the windows, shape of the windows, opacity of the windows, and state of the windows, i.e. open or closed. Additionally, the present invention enables settings for the windows to be automatically determined based on stored information and also based on detected attributes of the user computing system. Further, the present invention enables users to view information in windows within an Internet browser window in a consistent manner across different computing platforms and Internet browsers.

The present invention also takes advantage of the communication attributes of the Internet to enable a developer system to communicate with and control the windows within the Internet browser window from any remote location. Additionally, the present invention does not require any software at the user computing system, thus eliminating the need for downloads of software at the user computing system and increasing the overall speed of the application.

### BRIEF DESCRIPTION OF THE DRAWINGS

Referring now to the drawings, wherein like reference numerals designate identical or corresponding systems, devices, equipment, parts, components, elements, or steps throughout the different views.

FIG. 1 is a block diagram of a system for managing windows within an Internet environment in accordance with exemplary embodiments of the present invention;

FIG. 2 is a flow chart of a method for managing windows within an Internet environment in accordance with exemplary embodiments of the present invention; and

FIG. 3 is a flow chart of a method for initiating manipulation in windows within an Internet environment in accordance with exemplary embodiments of the present invention; and

FIG. 4 is a flow chart of a method for managing windows within an Internet environment with a developer in accordance with exemplary embodiments of the present invention.

### DETAILED DESCRIPTION

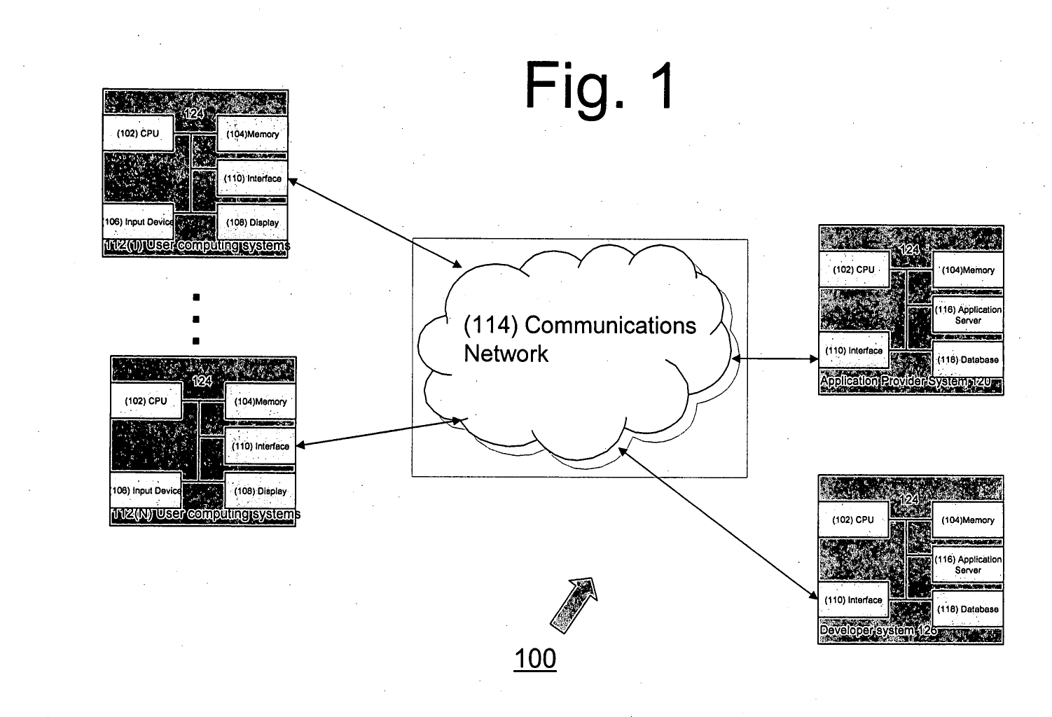

A system 100 for managing windows within an Internet environment in accordance with exemplary embodiments of the present invention is illustrated in FIG. 1. The system includes user computing systems 112(1)-112(n), an application provider system 120, a developer system 126, and a communications network 114, although the system 100 can include other numbers and types of systems, devices, equipment, parts, components, and/or elements in other configurations. The present invention provides a number of advantages including providing dynamic management over the display of one or more windows within an Internet browser window.

Referring more specifically to FIG. 1, each of the user computing systems 112(1)-112(n) enables a user to utilize an application from the application provider system 120, although one or more of the user computing systems 112(1)-112(n) could utilize other types and numbers of applications from other locations and could provide a wide variety of other functions for the user. Each of the user computing systems 112(1)-112(n) includes a central processing unit (CPU) or processor 102, a memory 104, user input device 106, a display 108, and an interface system 110, and which are coupled together by a bus or other link 124, although one or more of the user computing systems 112(1)-112(n) can include other numbers and types of components, parts, devices, systems, and elements in other configurations and locations.

The processor 102 executes a program of stored instructions for one or more aspects of the present invention as described and illustrated by way of the exemplary embodiments herein, including managing windows within an Internet browser window, although the processor 102 could execute other types of programmed instructions.

The memory 104 stores these programmed instructions for one or more aspects of the present invention as described and illustrated by way of the exemplary embodiments herein, including managing windows within an Internet browser window, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to one or more processors, can be used for the memory 104.

The user input device 106 is used to input selections, such as user desired location of windows, size of windows, background color of windows, opacity of windows, and state of windows, although the user input device 106 could be used to input other types of data and interact with other elements. The user input device 106 can include a computer keyboard, a computer mouse, and the like, although other types and numbers of user input devices 106 can be employed.

The display 108 is used to show data and information to the user, such as the applications in different windows which have different shapes, sizes, background colors, opacity, and state and with the windows configured in three dimensions within the Internet browser window by way of example only. The display 108 can include a computer display screen, such as a CRT or LCD screen, and the like, although other types and numbers of displays could be employed.

The interface system 110 is used to operatively couple and communicate between the user computing systems 112(1)-112(n) and the application provider system 120 and the developer system 126 via the communications network 114, although other types and numbers of connections with these and other types and numbers of systems, devices, components, and modules, in other configurations and with other types of communication systems can be employed. By way of example only, the communication network 114 can employ TCP/IP over Ethernet and industry-standard protocols, including SOAP, XML, LDAP, SNMP, and the like, although other types and numbers of communication networks, such as a direct connection, a local area network, a wide area network, modems and phone lines, e-mail, wireless communication technology, and the like, each having their own communications protocols, can be employed

The application provider system 120 provides a definition of attributes for layout settings via an application server 116 to the user computing systems 112(1)-112(n), where users can define attributes, such as relative locations of window placements, open windows, close windows, maximize windows, and minimize windows. The application provider system 120 also provides one or more applications to the user computing systems 12(1)-12(n), although the application provider system 120 can have other functionality and other numbers and types of application provider systems could be used. The application provider system 120 includes a central processing unit (CPU) or processor 102, a memory 104, interface system 110, application server 116, and database 118 which are coupled together by a bus or other link 124, although other numbers and types of components, parts, devices, systems, and elements in other configurations and locations can be used.

The processor 102 in the application provider system 120 executes a program of stored instructions one or more aspects of the present invention as described and illustrated by way of the exemplary embodiments herein, including managing windows within an Internet browser window.

The memory 104 stores these programmed instructions for one or more aspects of the present invention as described and illustrated by way of the exemplary embodiments herein including managing windows within an Internet browser window although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 102, can be used for the memory 104 in the application provider system 120.

The interface system 110 in the application provider system 120 is used to operatively couple and communicate between the application provider system 120 and the one or more user computing systems 112(1)-112(n) and the developer system 126 via communications network 114, although other types and numbers of connections with these and other types and numbers of systems, devices, components, and modules, in other configurations and with other types of communication systems can be employed. By way of example only, the communication network 114 can employ TCP/IP over Ethernet and industry-standard protocols, including SOAP, XML, LDAP, SNMP, and the like, although other types and numbers of communication networks, such as a direct connection, a local area network, a wide area network, modems and phone lines, e-mail, wireless communication technology, and the like, each having their own communications protocols, can be employed.

The application server 116 runs one or more applications that can be shared by one or more of the user computing system 12(1)-12(n) and also shares the data processing burden with the user computing system 12(1)-12(n), although other numbers and types of servers can be used and other functionality can be carried out by the application server 116. The database 118 stores user layout settings, predefined settings, and one or more applications, although other types and numbers of data storage devices can be employed and other types and amounts of information can be stored on the database server 118.

The developer system 126 enables a user at remote system to interact with and to input selections, such as desired location of windows, size of windows, background color of windows, opacity of windows, and state of windows, although other numbers and types of systems could be used and the developer system 126 could have other functionality. The developer system 126 includes a central processing unit (CPU) or processor 102, a memory 104, an interface system 110, an application server 116, and a database 118 which are coupled together by a bus or other link 124, although other numbers and types of components, parts, devices, systems, and elements in other configurations and locations could be used.

The processor 102 in the developer system 126 executes a program of stored instructions for one or more aspects of the present invention as described and illustrated by way of the exemplary embodiments herein, including managing windows within an Internet browser window.

The memory 104 stores these programmed instructions for one or more aspects of the present invention as described and illustrated by way of the exemplary embodiments herein including managing windows within an Internet browser window, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 102, can be used for the memory 104 in the developer system 126.

The interface system 110 in the developer system 126 is used to operatively couple and communicate between the developer system 126 and the application provider system 120 and the one or more user computing systems 112(1)-112(n) via communications network 114, although other types and numbers of connections with these and other types and numbers of systems, devices, components, and modules, in other configurations and with other types of communication systems can be employed. By way of example only, the communication network 114 can employ TCP/IP over Ethernet and industry-standard protocols, including SOAP, XML, LDAP, SNMP, and the like, although other types and numbers of communication networks, such as a direct connection, a local area network, a wide area network, modems and phone lines, e-mail, wireless communication technology, and the like, each having their own communications protocols, can be employed.

The application server 116 can also run one or more applications that can be shared by one or more of the user computing system 12(1)-12(n) and also shares the data processing burden with the user computing system 12(1)-12(n), although other numbers and types of servers can be used and other functionality can be carried out by the application server 116. The database 118 can also store layout settings, predefined settings, and one or more applications, although other types and numbers of data storage devices can be employed and other types and amounts of information can be stored on the database server 118.

Although exemplary embodiments of the user computing systems 112(1)-112(n), the application provider system 120, and the developer system 126 are described and illustrated herein, each of the user computing systems 112(1)-112(n), the application provider system 120, and the developer system 126 can be implemented on any suitable computer system or computing device, and the like. It is to be understood that the devices and systems of the embodiments described herein are for exemplary purposes, as many variations of the specific hardware and software used to implement the exemplary embodiments are possible, as will be appreciated by those skilled in the relevant art(s).

Furthermore, each of the systems of the exemplary embodiments may be conveniently implemented using one or more general purpose computer systems, microprocessors, digital signal processors, micro-controllers, and the like, programmed according to the teachings of the exemplary embodiments, as described and illustrated herein, and as will be appreciated by those skilled in the computer and software arts.

In addition, two or more computing systems or devices can be substituted for any one of the systems in any embodiment of the exemplary embodiments. Accordingly, principles and advantages of distributed processing, such as redundancy, replication, and the like, also can be implemented, as desired, to increase the robustness and performance of the devices and systems of the exemplary embodiments. The exemplary embodiments may also be implemented on computer system or systems that extend across any suitable network using any suitable interface mechanisms and communications technologies, including by way of example only telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, and combinations thereof.

The exemplary embodiments may also be embodied as a computer readable medium having instructions stored thereon for managing windows within an Internet browser window, as described herein, which when executed by a processor, cause the processor to carry out the steps necessary to implement the methods of the exemplary embodiments, as described and illustrated herein.

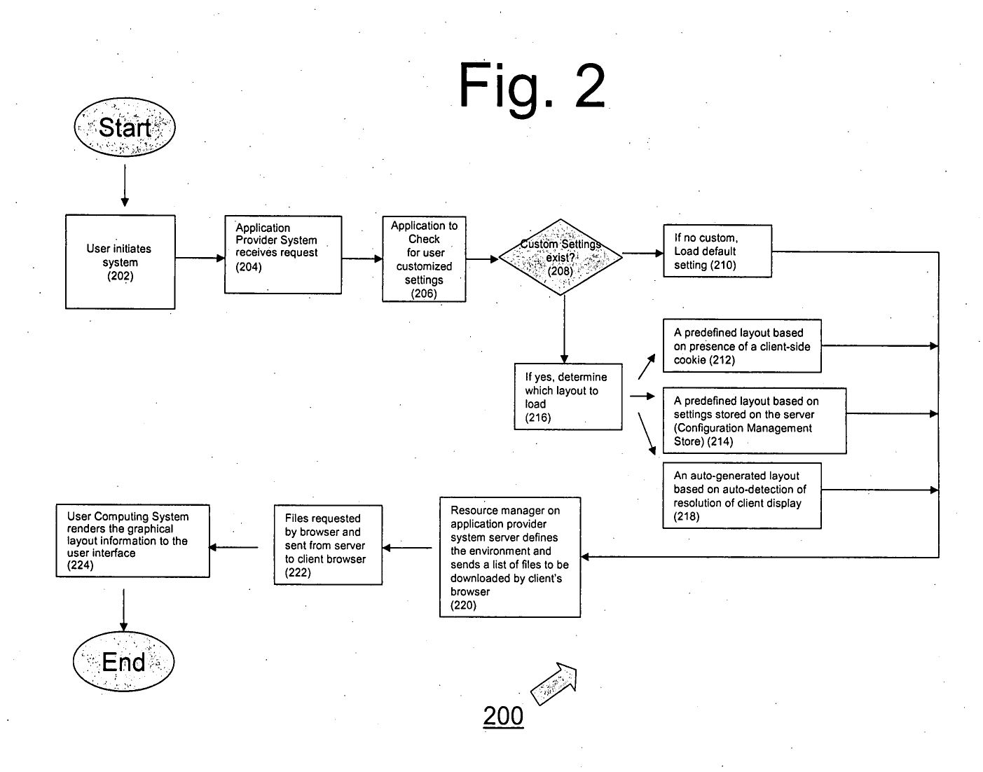

The operation of the system 100 in accordance with the exemplary embodiments will now be described with reference to FIGS. 1-2. In step 202, a user using an input device 106 at one of the user computing system 112(1)-112(n) initiates an interaction event request, such as clicking on a link in an application using the input device 106 by way of example only. The interaction event request is transmitted from the one of the user computing system 112(1)-112(n) to the application provider system 120 via the communications network 114, although other manners for transmitting the interaction event could be used. In step 204, the application provider system 120 receives the interaction event request from the one of the user computing system 112(1)-112(n). In step 206, the application provider system 120 queries the database 118 to determine if customized layout settings for windows exist for the one of the user computing systems 112(1)-112(n).

In step 208, based on the query the application provider system 120 determines if any custom layout settings are stored in the database 118 in the application provider system 120. If the application provider system 120 determines there are no custom settings stored in the database 118 in the application provider system 120 for the one of the user computing systems 112(1)-112(n) which initiated the interaction event request, then the No branch is taken to step 210. In step 210, the default layout setting for windows for the one of the user computing systems 112(1)-112(n) which initiated the interaction event request is retrieved. If the application provider system 120 determines there are one or more custom layout settings for windows available for the one of the user computing systems 112(1)-112(n) which initiated the interaction event request, then the Yes branch is taken to step 216.

In step 216, the application provider system 120 uses JavaScript to determine which of the custom layout settings for windows identified in the query is closest to a custom layout for the display 108 should be loaded into the one of the user computing systems 112(1)-112(n) which initiated the interaction event request based on one or more criteria, such as screen width and height (i.e. resolution) for the display 108 or the name of the particular one of the user computing systems 112(1)-112(n) which initiated the interaction event request (for example, to differentiate between a work computing system and a home computing system), although other types of criteria could be used.

If in step 216 the application provider system 120 determines one of the user computing systems 112(1)-112(n) has a cookie with a layout setting for windows, then it proceeds to step 212. In step 212, the application provider system 120 obtains the layout setting for windows from the cookie.

If in step 216 the application provider system 120 determines one of the user computing systems 112(1)-112(n) has one or more stored layout settings in the database 116 in the application provider system 120, then it proceeds to step 214. In step 214, the application provider system 120 selects and obtains one of the stored layout settings for windows from the database 116 in the application provider system 120. If more than one stored layout setting is available, the application provider system 120 selects one of the stored layout settings based on a stored ranking preference in database 116, although other manners for selecting one of the layout settings can be used.

If in step 216 the application provider system 120 has detected one or more characteristics of the one of the user computing systems 112(1)-112(n) which initiated the interaction event request, such as the resolution of the display 108 on the one of the user computing systems 112(1)-112(n), then the application provider system 120 generates a layout setting for windows based on the detected one or more characteristics and stored data in database 118, although the layout setting can be generated in other manners.

In step 220, the application provider system 120 provides dynamic prioritized resource loading with progress monitoring for loading the layout setting obtained in step 212, 214, or 218 in the Internet browser window on the one of the user computing systems 112(1)-112(n) which initiated the interaction event request along with one or more additional resources stored in database 118 in application provider system 120 which may be necessary. By way of example only, the resources may include ASCII, Images, CSS, and JavaScript.

In step 222, the layout setting for windows obtained by the application provider system 120 along with any necessary resource or resources are requested by the Internet browser of the user of one of the computing system 112(1)-112(n) which initiated the interaction event request. In step 224, in the application provider system 120 renders the layout setting for windows on the Internet browser window on the one of the user computing systems 112(1)-112(n) which initiated the interaction event request.

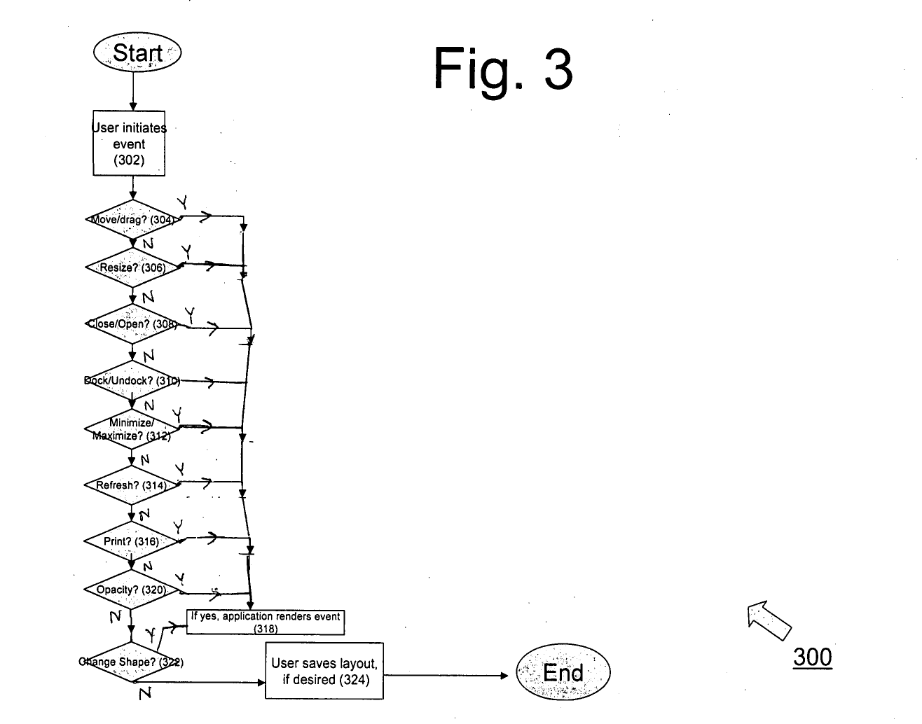

The operation of the exemplary system 100 in accordance with other exemplary embodiments will now be described with reference to FIGS. 1 and 3. In step 302, the user using the input device 106 at one of the user computing systems 112(1)-112(n) initiates a window manipulation event with respect to one of the windows in the Internet browser window. The window manipulation event is transmitted from the one of the user computing system 112(1)-112(n) to the application provider system 120 via the communications network 114, although other manners for transmitting the window manipulation event could be used.

In step 304, the application provider system 120 receives the window manipulation event from the one of the user computing system 112(1)-112(n) and determines if the window manipulation event is a request to move or drag the window to another location. If the application provider system 12 determines the window manipulation event is a request to move or drag the window to another location, then the Yes branch is taken to step 318. In step 318, the application provider system 120 renders the request to move or drag the window to another location in the Internet browser window in the one of the user computing system 112(1)-112(n) that initiated this window manipulation event and then returns to step 302. If the application provider system 120 determines the window manipulation event is not a request to move or drag the window to another location, then the No branch is taken to step 306.

In step 306, the application provider system 120 determines if the window manipulation event from the one of the user computing system 112(1)-112(n) is a request to resize the window. If the application provider system 12 determines the window manipulation event is a request to resize the window, then the Yes branch is taken to step 318. In step 318, the application provider system 120 renders the request to resize the window in the Internet browser window in the one of the user computing system 112(1)-112(n) that initiated this window manipulation event and then returns to step 302. If the application provider system 120 determines the window manipulation event is not a request to resize the window, then the No branch is taken to step 308.

In step 308, the application provider system 120 determines if the window manipulation event from the one of the user computing system 112(1)-112(n) is a request to close or open the window. If the application provider system 12 determines the window manipulation event is a request to open or close the window, then the Yes branch is taken to step 318. In step 318, the application provider system 120 renders the request to open or close the window in the Internet browser window in the one of the user computing system 112(1)-112(n) that initiated this window manipulation event and then returns to step 302. If the application provider system 120 determines the window manipulation event is not a request to open or close the window, then the No branch is taken to step 310.

In step 310, the application provider system 120 determines if the window manipulation event from the one of the user computing system 112(1)-112(n) is a request to dock and unlock the window. If the application provider system 12 determines the window manipulation event is a request to dock and unlock the window, then the Yes branch is taken to step 318. In step 318, the application provider system 120 renders the request to dock and unlock the window in the Internet browser window in the one of the user computing system 112(1)-112(n) that initiated this window manipulation event and then returns to step 302. If the application provider system 120 determines the window manipulation event is not a request to dock and unlock the window, then the No branch is taken to step 312.

In step 312, the application provider system 120 determines if the window manipulation event from the one of the user computing system 112(1)-112(n) is a request to minimize or maximize the window. If the application provider system 12 determines the window manipulation event is a request to minimize or maximize the window, then the Yes branch is taken to step 318. In step 318, the application provider system 120 renders the request to minimize or maximize the window in the Internet browser window in the one of the user computing system 112(1)-112(n) that initiated this window manipulation event and then returns to step 302. If the application provider system 120 determines the window manipulation event is not a request to minimize or maximize the window, then the No branch is taken to step 314.

In step 314, the application provider system 120 determines if the window manipulation event from the one of the user computing system 112(1)-112(n) is a request to refresh the window. If the application provider system 12 determines the window manipulation event is a request to refresh the window, then the Yes branch is taken to step 318. In step 318, the application provider system 120 renders the request to refresh the window in the Internet browser window in the one of the user computing system 112(1)-112(n) that initiated this window manipulation event and then returns to step 302. If the application provider system 120 determines the window manipulation event is not a request to refresh the window, then the No branch is taken to step 316.

In step 316, the application provider system 120 determines if the window manipulation event from the one of the user computing system 112(1)-112(n) is a request to print the window. If the application provider system 12 determines the window manipulation event is a request to print the window, then the Yes branch is taken to step 318. In step 318, the application provider system 120 renders the request to print the window in the Internet browser window in the one of the user computing system 112(1)-112(n) that initiated this window manipulation event and then returns to step 302. If the application provider system 120 determines the window manipulation event is not a request to print the window, then the No branch is taken to step 320.

In step 320, the application provider system 120 determines if the window manipulation event from the one of the user computing system 112(1)-112(n) is a request to change the opacity of the window. If the application provider system 12 determines the window manipulation event is a request to change the opacity of the window, then the Yes branch is taken to step 318. In step 318, the application provider system 120 renders the request to change the opacity of the window in the Internet browser window in the one of the user computing system 112(1)-112(n) that initiated this window manipulation event and then returns to step 302. If the application provider system 120 determines the window manipulation event is not a request to change the opacity of the window, then the No branch is taken to step 322.

In step 322, the application provider system 120 determines if the window manipulation event from the one of the user computing system 112(1)-112(n) is a request to change the shape of the window. If the application provider system 12 determines the window manipulation event is a request to change the shape of the window, then the Yes branch is taken to step 318. In step 318, the application provider system 120 renders the request to change the shape of the window in the Internet browser window in the one of the user computing system 112(1)-112(n) that initiated this window manipulation event and then returns to step 302. If the application provider system 120 determines the window manipulation event is not a request to change the shape of the window, then the No branch is taken to step 324.

The attributes for the windows which are discussed above are by way of example only and other types and numbers of attributes for the windows can be manipulated. Additionally, other orders and manners to determine which attributes should be rendered by the application provider system 120 could be used.

In step 324, the user of the one of the user computing systems 112(1)-112(n) can request to save the existing layout setting as a pre defined template for future use. If a request to save the existing layout setting is received, then a cookie with this layout setting is stored at the one of the user computing systems 112(1)-112(n), although the cookie could be stored at other locations in other manners, such as in the database 118 at the application provider system 120.

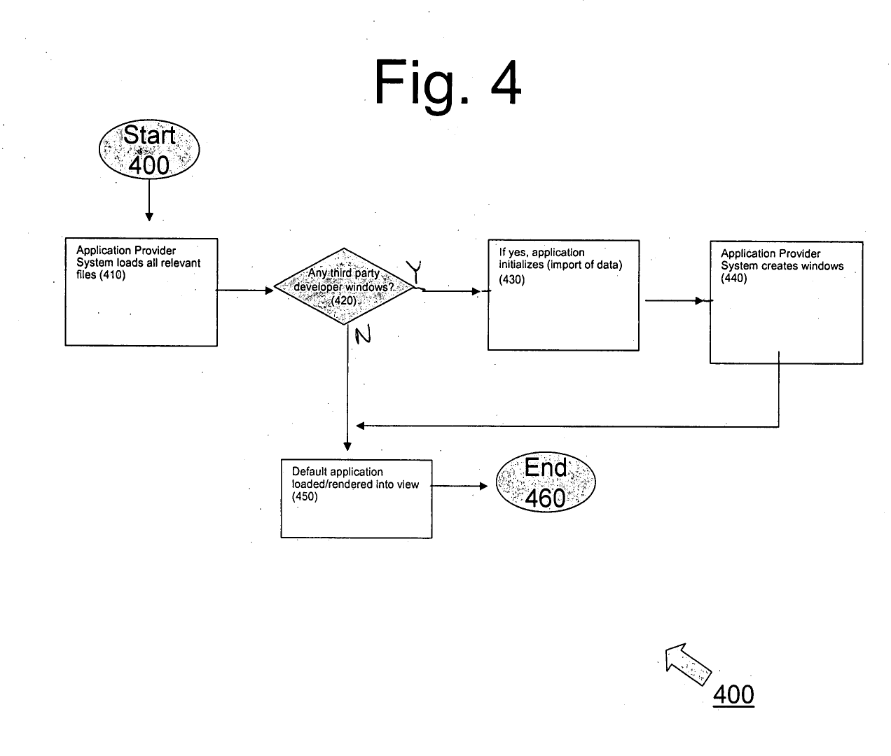

The operation of the exemplary system 100 in accordance with other exemplary embodiments will now be described with reference to FIGS. 1 and 4. In step 400, the application provider system 120 loads JavaScript code files from database 118 to create the layout setting, although other numbers and types of files can be loaded and the files can be retrieved from other locations.

In step 420, the application provider system 120 determines if there is any third party software and content to be displayed in the layout setting or settings, such as a personal information manager and communication system. If the application provider system 120 determines there is third party software and content to display, then the Yes branch is taken to step 430.

In step 430, the application provider system 120 initializes import of data and/or instructions from memory 104 and/or database 118 in application provider system 120 which are needed to create the window(s), such as data and/or instructions on the window layout, size of the window(s), and opacity, by way of example only, although the data and/or instructions can be retrieved from other locations.

In step 440, the application provider system 120 creates the window(s) on the user computing system 112(1)-112(n) based on the imported data and/or instructions.

In step 450, the default application is loaded and rendered on the user computing system 112(1)-112(n). The default application is any type of selected content that would be loaded into a web page/web window.

Accordingly, as illustrated by the exemplary embodiments described herein the present invention provides dynamic management over the display of one or more windows within an Internet browser window. The present invention allows attributes to be selected for settings for the windows, enables settings for the windows to be automatically determined based on stored information and based on detected attributes of the user computing system. Additionally, the present invention enables users to view information in windows within an Internet browser window in a consistent manner across different computing platforms and Internet browsers. Further, as illustrated herein the present invention takes advantage of the communication attributes of the Internet to enable a developer system to communicate with and control the windows within the Internet browser window from any remote location.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing windows within an Internet environment, the method comprising:
determining at a first system which of one or more of settings to use for one or more windows within an Internet browser window in a second system remote from the first system, wherein at least one of one or more attributes in the one or more settings is adjustable; and
docking the one or more windows with the determined one of the settings in the Internet browser window in the second system.

2. The method as set forth in claim 1 wherein the determining further comprises:
identifying when one or more custom settings exist;
deciding which of the one or more custom settings is the determined one of the settings when the identifying determines the one or more custom settings exist; and
deciding the determined one of the settings is a default setting when the identifying determines the one or more custom settings do not exist.

3. The method as set forth in claim 2 wherein the deciding which of the one or more custom settings is the determined one of the settings further comprises deciding whether at least one of: a custom setting in a cookie from the second system; a custom setting stored at the first system; and a custom setting generated based on a detected resolution of a display at the second system is the determined one of the settings.

4. The method as set forth in claim 1 further comprising:
receiving one or more input attributes for the one or more attributes for the one or more settings; and
storing the input attributes for the one or more attributes for the one or more settings at the first system, wherein the one or more windows are based on the stored input attributes for the determined one of the settings.

5. The method as set forth in claim 4 wherein the one or more attributes comprise at least one of a size, relative position, color, shape, and state of the one or more windows.

6. The method as set forth in claim 1 further comprising:
detecting one or more system attributes at the second system for the one or more settings; and
storing the system attributes for the one or more attributes for the one or more settings at the first system, wherein the one or more windows are based on the stored system attributes for the determined one of the settings.

7. The method as set forth in claim 1 wherein the docking further comprises rendering a three dimensional display for the one or more of the windows in the Internet browser window in the second system.

8. The method as set forth in claim 1 further comprising initiating one or more of manipulation events in one or more of the windows in the Internet browser window in the second system based on one or more received requests.

9. The method as set forth in claim 8 wherein the one or more manipulation events further comprise at least one of move, drag, resize, close, open, dock, undock, minimize, maximize, refresh, print, change opacity, and change shape.

10. The method as set forth in claim 1 further comprising providing at least one application programming interface to permit remote adjustment of the determined one of the settings for the one or more windows in the Internet browser window in the second system.

11. A computer readable medium having stored thereon instructions for managing windows within an Internet environment comprising machine executable code which when executed by at least one processor, causes the processor to perform steps comprising:
determining at a first system which of one or more of settings to use for one or more windows within an Internet browser window in a second system remote from the first system, wherein at least one of one or more attributes in the one or more settings is adjustable; and
docking the one or more windows with the determined one of the settings in the Internet browser window in the second system.

12. The medium as set forth in claim 11 wherein the determining further comprises:
identifying when one or more custom settings exist;
deciding which of the one or more custom settings is the determined one of the settings when the identifying determines the one or more custom settings exist; and
deciding the determined one of the settings is a default setting when the identifying determines the one or more custom settings do not exist.

13. The medium as set forth in claim 12 wherein the deciding which of the one or more custom settings is the determined one of the settings further comprises deciding whether at least one of: a custom setting in a cookie from the second system; a custom setting stored at the first system; and a custom setting generated based on a detected resolution of a display at the second system is the determined one of the settings.

14. The medium as set forth in claim 11 further comprising:
receiving one or more input attributes for the one or more attributes for the one or more settings; and
storing the input attributes for the one or more attributes for the one or more settings at the first system, wherein the one or more windows are based on the stored input attributes for the determined one of the settings.

15. The medium as set forth in claim 14 wherein the one or more attributes comprise at least one of a size, relative position, color, shape, and state of the one or more windows.

16. The medium as set forth in claim 11 further comprising:
detecting one or more system attributes at the second system for the one or more settings; and
storing the system attributes for the one or more attributes for the one or more settings at the first system, wherein the one or more windows are based on the stored system attributes for the determined one of the settings.

17. The medium as set forth in claim 11 wherein the docking further comprises rendering a three dimensional display for the one or more of the windows in the Internet browser window in the second system.

18. The medium as set forth in claim 11 further comprising initiating one or more of manipulation events in one or more of the windows in the Internet browser window in the second system based on one or more received requests.

19. The medium as set forth in claim 18 wherein the one or more manipulation events further comprise at least one of move, drag, resize, close, open, dock, undock, minimize, maximize, refresh, print, change opacity, and change shape.

20. The medium as set forth in claim 11 further comprising providing at least one application programming interface to permit remote adjustment of the determined one of the settings for the one or more windows in the Internet browser window in the second system.

21. A system for managing windows within an Internet environment, the system comprising:
a determination processing system that determines at a first system which of one or more of settings to use for one or more windows within an Internet browser window in a second system remote from the first system, wherein at least one of one or more attributes in the one or more settings is adjustable; and
a docking system that docks the one or more windows with the determined one of the settings in the Internet browser window in the second system.

22. The system as set forth in claim 21 wherein the determination processing system further comprises:
an identification system that identifies when one or more custom settings exist; and
a decision processing system that decides which of the one or more custom settings is the determined one of the settings when the identifying determines the one or more custom settings exist and which decides the determined one of the settings is a default setting when the identifying determines the one or more custom settings do not exist.

23. The system as set forth in claim 22 wherein the decision processing system decides whether at least one of: a custom setting in a cookie from the second system; a custom setting stored at the first system; and a custom setting generated based on a detected resolution of a display at the second system is the determined one of the settings.

24. The system as set forth in claim 21 further comprising:
a communication system that receives one or more input attributes for the one or more attributes for the one or more settings; and
a storage system that stores the input attributes for the one or more attributes for the one or more settings at the first system, wherein the one or more windows are based on the stored input attributes for the determined one of the settings.

25. The system as set forth in claim 24 wherein the one or more attributes comprise at least one of a size, relative position, color, shape, and state of the one or more windows.

26. The system as set forth in claim 21 further comprising:
a detection system that detects one or more system attributes at the second system for the one or more settings; and
a storage system that stores the system attributes for the one or more attributes for the one or more settings at the first system, wherein the one or more windows are based on the stored system attributes for the determined one of the settings.

27. The system as set forth in claim 21 wherein the docking system further comprises a rendering system that renders a three dimensional display for the one or more of the windows in the Internet browser window in the second system.

28. The system as set forth in claim 21 further comprising a windows manipulation processing system that initiates one or more of manipulation events in one or more of the windows in the Internet browser window in the second system based on one or more received requests.

29. The system as set forth in claim 28 wherein the one or more manipulation events further comprise at least one of move, drag, resize, close, open, dock, undock, minimize, maximize, refresh, print, change opacity, and change shape.

30. The system as set forth in claim 21 further comprising at least one application programming interface module to permit remote adjustment of the determined one of the settings for the one or more windows in the Internet browser window in the second system.
